(19) United States
(12) Patent Application Publication
(10) Pub. No.: US 2026/0214510 A1
(43) Pub. Date: Jul. 23, 2026

(54) SYSTEM AND METHOD FOR LOAD BALANCING IN A SOFTWARE-DEFINED WIRELESS SENSOR NETWORK

(71) Applicant: Nanning FuLian FuGui Precision Industrial Co., Ltd., Nanning (CN)

(72) Inventors: Zheng-Hao GAO, New Taipei (TW); Jhen-Tang DAI, New Taipei (TW)

(21) Appl. No.: 19/034,982

(22) Filed: Jan. 23, 2025

(51) Int. Cl. H04W 28/086; H04W 28/08; H04W 84/18; H04W 88/16

(52) U.S. Cl. CPC H04W 28/086; H04W 28/0942; H04W 28/0967; H04W 84/18; H04W 88/16

(57) ABSTRACT

A system and method for load balancing in a software-defined wireless sensor network, comprising a first controller detects the load of multiple transmission paths between a gateway and multiple nodes. The first controller sends an overload warning message to a second controller, when the ratio of overloaded of transmission paths exceeds a threshold value. Then the second controller adds the first controller to an observation list and stops assigning new gateways to the first controller in the observation list.

### FIELD

The subject matter herein generally relates to a field of wireless communication technology, particularly a system and method for load balancing in a software-defined wireless sensor network.

### BACKGROUND

With the widespread application of wireless sensor networks, there has been an increase in the demand for applications with high data flow variation and the coexistence of multiple types of data. However, traditional routing methods for sensor networks require sensor nodes to participate, which impacts the lifespan of these sensor nodes, which already have limited energy.

To effectively manage the transmission paths of wireless sensor networks and extend the lifespan of sensor nodes, the application of software-defined networking (SDN) technology in wireless sensor networks, known as software-defined wireless sensor networks, has garnered increasing attention. Although software-defined wireless sensor networks can balance traffic within the network through algorithms to extend the lifespan of sensor nodes, current algorithms cannot handle the sudden large-scale path changes caused by sensor node failures, leading to the issue of SDN controller overload.

Therefore, there is a need for a system and method for load balancing in a software-defined wireless sensor network that can effectively balance the load of SDN controllers, avoid overloading of a single SDN controller, and improve the stability and reliability of software-defined wireless sensor networks.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a schematic diagram of an embodiment of a system for load balancing;

FIG. 2 is a flowchart of an embodiment of a method for load balancing;

FIG. 3 is a flowchart of an embodiment of a method for migrating the load of a high-load controller.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to;” it specifically indicates open-ended inclusion or membership in the so-described combination, group, series, and the like.

The present invention relates to a system and method for load balancing in a software-defined wireless sensor network. It is designed to prevent the issue of sudden large-scale path changes caused by sensor node failures within a Software-Defined Networking (SDN) architecture. This approach avoids overloading controllers with additional path adjustment tasks, which could otherwise result in controller overload.

In an SDN architecture, it includes the infrastructure layer, control layer, and application layer. The infrastructure layer consists of gateways, which are edge devices, and sensor nodes or routing nodes, which are terminal devices. The gateway serves as a bridge for communication between the control layer and the terminal devices at the lower layer. The gateway can communicate with the lower-layer terminal devices via wireless communication, while using traditional wired communication methods to transmit data to the control layer's cloud devices at the upper layer.

The control layer defines the controllers of the cloud device network. The controllers can sense the status of all nodes in the network to make corresponding decisions to control the operation of the network. The controllers are implemented through cloud resources, with network management and security management mechanisms deployed in the control layer.

The application layer is based on cloud data servers and meets the demands of different application scenarios by developing corresponding applications.

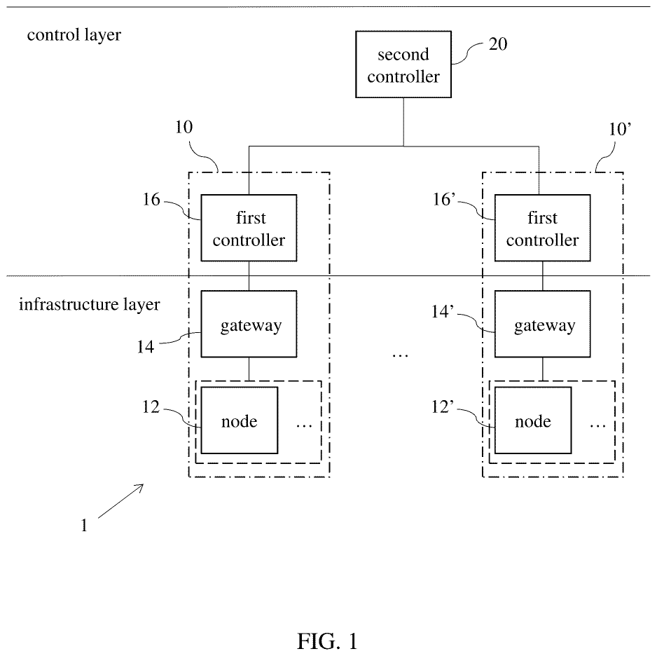

Please refer to FIG. 1 to describe the system architecture of the embodiment. The system in this embodiment primarily applies the control layer and infrastructure layer of the SDN architecture to the management of wireless sensor nodes. As shown in FIG. 1, the load balancing system 1 includes multiple nodes 12, 12′, gateways 14, 14′, first controllers 16, 16′, and a second controller 20, which are connected in sequence. It should be noted that FIG. 1 is merely an example and should not be interpreted as a limitation of the present invention. For instance, the number of gateways 14 connected to the first controller 16 may also be multiple; additional first controllers 16, 16′ may also be deployed.

The multiple nodes 12, 12′ and gateways 14, 14′ are categorized under the infrastructure layer in the SDN architecture. The first controllers 16, 16′ and the second controller 20 are categorized under the control layer in the SDN architecture. The second controller 20 can communicate with the data server (not shown in FIG. 1) in the application layer (not shown in FIG. 1) through wired or wireless connections.

In this embodiment, the multiple nodes 12, 12′ include sensor nodes and router nodes. Taking industrial IoT as an example, when the multiple nodes 12, 12′ are sensor nodes, they can be installed on robotic arms, conveyor belts, products, etc., to monitor these components and generate sensing data. The sensor nodes can transmit the sensing data directly to the gateways 14, 14′. The sensor nodes can also send the sensing data to a nearby router node, which then forwards it to the gateways 14, 14′. In this embodiment, the router nodes are used for relay data transmission between multiple sensor nodes and the gateways 14, 14′, while also receiving routing rules from the first controllers 16, 16′ to ensure that the data flow follows the optimal path. The router nodes are also responsible for monitoring their own and states of neighboring nodes, such as path load, and reporting this information to the first controllers 16, 16′ for receiving routing configuration instructions.

The gateways 14, 14′ can be devices such as modems, hubs, bridges, or switches. The gateways 14, 14′ are communicatively connected between the multiple nodes 12, 12′ and the first controllers 16, 16′, thereby integrating the heterogeneous wireless sensor network with the SDN network architecture. In this embodiment, the gateways 14, 14′ are used to forward data packets to the specified paths according to the flow table rules issued by the first controllers 16, 16′, while also receiving instructions from the first controllers 16, 16′ to reconfigure the data flow paths, thus alleviating the pressure on high-load nodes.

In this embodiment, in order to adapt to application scenarios with a large number of nodes or a wide distribution range, an architecture with multiple controllers is adopted, specifically the first controllers 16 and 16′. The first controllers 16, 16′ can be deployed in locations geographically close to the multiple nodes 12, 12′ to reduce the communication delay between the nodes 12, 12′ and the first controllers 16, 16′. The first controllers 16, 16′ are respectively responsible for managing the multiple nodes 12, 12′ and the gateways 14, 14′, and form control domains 10, 10′.

The first controllers 16, 16′ are used to manage the network topology and routing tables within their control domains 10, 10′. They calculate the optimal route based on network information and issue flow table rules to the gateways 14, 14′. At the same time, the first controllers 16, 16′ are also used to dynamically adjust the routing based on the real-time status of the multiple nodes 12, 12′ to prevent overload on any single node.

The second controller 20 is used to coordinate the first controllers 16, 16′ and implement dynamic load balancing. For example, when the load on the first controller 16 is too high, the gateway 14 can be dynamically migrated to the first controller 16′ with a lower load.

To improve the stability and reliability of the system, it is necessary to avoid situations where a single controller may experience sudden overload. For example, in the context of control domain 10, when one of the multiple nodes 12 fails, it may cause neighboring nodes to frequently report abnormal statuses to the gateway 14 and the first controller 16, such as link failure or data transmission errors, which increases the communication load on the first controller 16. At the same time, the first controller 16 also needs to issue updated flow table rules to the gateway 14 or router nodes, further increasing the communication demands on the first controller 16. Particularly in scenarios where multiple nodes 12 form large-scale wireless sensor networks, frequent node failures may also increase the frequency of topology updates, resulting in sudden overload on the first controller 16.

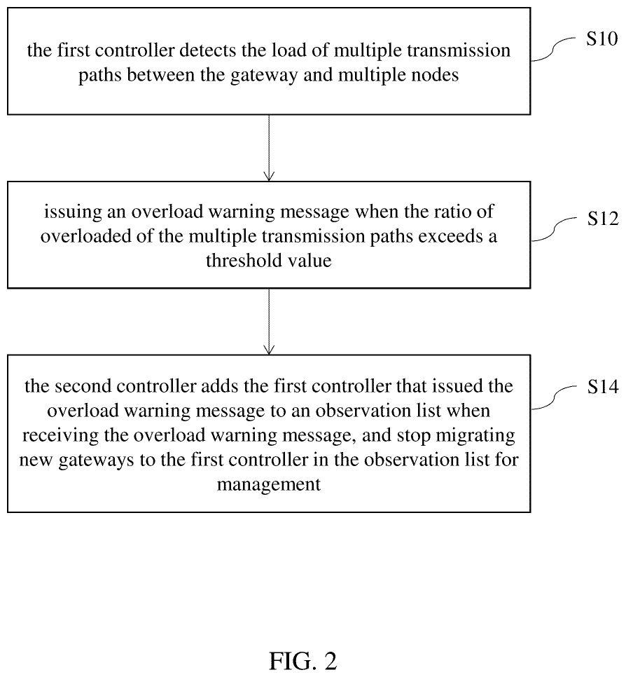

To achieve dynamic load balancing between the first controller 16 and the first controller 16′, refer to FIG. 2, which shows a flowchart of an embodiment of a method for load balancing executed by the first controllers 16 and 16′. The explanation of the steps in the flowchart uses the first controller 16 as an example, and the same applies to the first controller 16′, which will not be repeated here.

As shown in step S10, the first controller 16 estimates the load of multiple transmission paths between the gateway 14 and the multiple nodes 12.

For example, the first controller 16 can estimate the load of multiple transmission paths based on the topology map of control domain 10 it maintains, combined with traffic statistics data of the gateway 14 and multiple nodes 12.

In one example, the load of each transmission path can be calculated using the following load equation formula:

$$Transmission Path Load = {\sum }_{i ∈ path nodes} node load + {\sum }_{j ∈ path links} link load ,$$

the node load refers to the amount of data processed by a node along the transmission path or the remaining energy of the node; link load refers to the data rate or the remaining energy between nodes communicating.

Next, in step S12, when the first controller 16 detects that the ratio of overloaded of transmission paths exceeds a threshold value, the first controller 16 sends an overload warning message to the second controller 20. For example, an overload situation occurs when the bandwidth utilization of a transmission path has reached 90%, which is considered overloaded. The threshold value can be set to 75%. When the number of overloaded transmission paths accounts for 76% of the total transmission paths, this exceeds the threshold value, and at this point, the first controller 16 sends an overload warning message to the second controller 20. The overload warning message may include identity information of the first controller 16 itself, allowing the second controller 20 to identify which first controller 16 sent the overload warning message.

Next, in step S14, after the second controller 20 receives the overload warning message, it confirms the identity of the first controller 16 that sent the overload warning message based on the identity information. The first controller 16 that issued the overload warning message is then added to the observation list. When load balancing is subsequently triggered, new gateways 14 will not be migrated to the first controller 16 in the observation list for management.

Through the above method, the second controller 20 ensures that when the system initiates load balancing, new gateways will not be migrated to the first controller 16 in the observation list for management, thereby avoiding the risk of overloading the first controller 16. For example, if there is a need to migrate the gateway 14′ managed by the first controller 16′, the second controller 20 will not migrate gateway 14′ to first controller 16 for management, thus preventing first controller 16 from having to issue updated flow table rules to gateway 14′ or router nodes, which would increase the workload and potentially cause overloading of first controller 16.

In addition to the observation list, the second controller 20 further maintains a high-load list and a low-load list. The second controller 20 can categorize the first controllers 16, 16′ into the high-load list and low-load list based on their load status. During subsequent load balancing, the second controller 20 can quickly select a first controller 16, 16′ from the low-load list to add more load. The categorization method will be explained as follows.

In this embodiment, there are multiple control domains 10, 10′, and each first controller 16, 16′ within the control domains 10, 10′ periodically sends load information to the second controller 20. The load information includes the processor usage rate of the first controllers 16, 16′, the total number of packets processed by the first controllers 16, 16′, and the identity information of the first controllers 16, 16′, etc. Upon receiving the load information, the second controller 20 can determine which first controller 16, 16′ the load information belongs to base on the identity information in the load message, and can also assess the load status of the first controllers 16, 16′ based on the processor usage rate and the total number of packets processed.

In this embodiment, the first controllers 16, 16′ can also adjust the reporting frequency of load information to the second controller 20. In one example, the reporting frequency increases as the load increases.

In one example, the reporting frequency can mainly be adjusted based on the number of packets processed by the first controllers 16, 16′. The reporting frequency can be adjusted according to the following reporting frequency equation:

$${F}_{{t}_{i}} = \frac{{R}_{{t}_{i}} - {R}_{{t}_{i - 1}}}{{t}_{i} - {t}_{i - 1}} ,$$

the Fₜ_{ᵢ} is the reporting frequency, the tᵢ is a time point, and the Rₜ_{ᵢ} is expressed by the following equation:

$${R}_{{t}_{i}} = \frac{\sum {T}_{packet \_ OUT} - {T}_{packet \_ IN}}{Packet\_Count} ,$$

the T_{packet_OUT} is amount of packets output by the first controller 6, 16′, the T_{packet_IN} is amount of packets input to the first controller 16, 16′, and the Packet_Count is total number of packets input and output by the first controller 16, 16′.

The second controller 20, upon receiving the load information, classifies the first controllers 16, 16′ of multiple network control domains 10, 10′ based on the load information. The second controller 20 can receive load information from the first controllers 16, 16′ within the same time period, such as within one second. The second controller 20 adds the first controller 16 to a high-load list when the load information sent by the at least one first controller 16 exceeds the load threshold, the second controller 20 adds the first controller 16′ to a low-load list when the load information sent by the first controller 16′ is below the load threshold. For example, the load threshold includes the processor usage threshold and the total packet processing threshold. For instance, the processor usage threshold is set to 90%, and the total packet threshold is set to 8333 packets/per second. When both the processor usage and the total packet count in the load information exceed the processor usage threshold and the total packet threshold, or exceed one of them, it is defined as exceeding the load threshold. When both the processor usage and the total packet count in the load information are below the processor usage threshold and the total packet threshold, it is defined as being below the load threshold.

After the second controller 20 classifies the first controllers 16, 16′ in multiple control domains 10, 10′, it can quickly identify which first controllers 16, 16′ are in high-load conditions and which are in low-load conditions. This classification helps the second controller 20 allocate the load of first controllers 16, 16′ when performing load balancing adjustments.

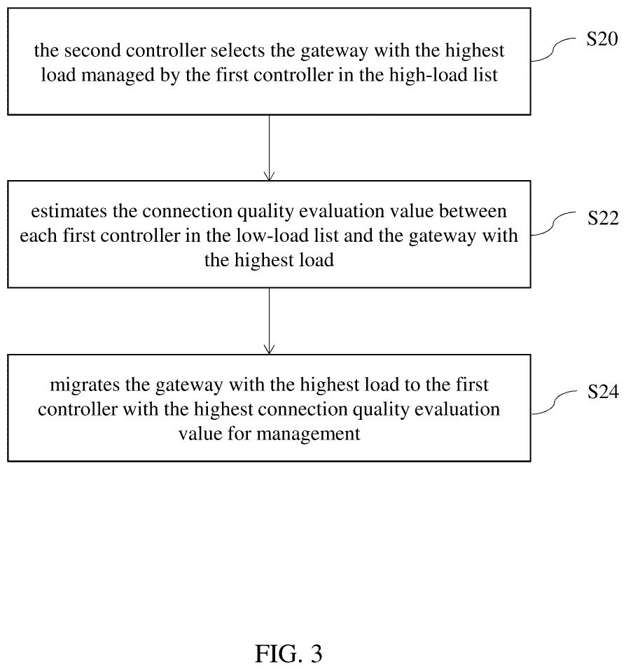

Please refer to FIG. 1 and FIG. 3 to explain the method for migrating the load of a high-load controller executed by the second controller 20. In this embodiment, the first controller 16 in control domain 10 is classified into the high-load list and is the first controller 16 with the highest load. The first controller 16′ in control domain 10′ is classified into the low-load list. In this embodiment, there may be multiple first controllers 16 in the high-load list, and there may also be multiple first controllers 16′ in the low-load list.

Step S20, the second controller 20 selects multiple first controllers 16 from the high-load list. Then, from each of the selected first controllers 16, and the second controller 20 selects the gateway 14 with the highest load managed by the first controller 16. The determination of the gateway with the highest load can be based on the packet processing volume and the processor processing capacity of the gateway 14. The higher the packet processing volume and the processor's processing capacity, the higher the load.”

Step S22, the second controller 20 estimates the connection quality evaluation value between each first controller 16′ in the low-load list and the gateway 14 with the highest load managed by each of the first controllers 16. In this example, there are 10 first controllers 16′ in the low-load list. When estimating the connection quality evaluation value, the second controller 20 will evaluate the connection quality between each highest load gateway 14 and the 10 first controllers 16′, resulting in 10 connection quality evaluation value for each highest load gateway 14.

The connection quality evaluation value can be estimated using the evaluation formula, as shown below:

$$E = {W}_{l} \times ( {L}_{thres} - {L}_{curr} ) - {W}_{h} \times {H}_{count} ,$$

where the E is the connection quality evaluation value, the Wₗ and the Wₕ are weights, the Lₜₕᵣₑₛ is a load limit of the first controller 16′, the L_{curr} is a load value of one of the first controller 16′ in the low-load list, and the H_{count} is the number of relay points through which the at least one of gateway with the highest load connected to one of the first controller in the low-load list.

After calculating the connection quality evaluation value for each highest load gateway 14, proceed to step S24. The second controller 20 selects, from the 10 connection quality values corresponding to the highest load gateway 14, the first controller 16′ with the highest connection quality evaluation value, and migrates each highest load gateway 14 to the first controller 16 with the highest connection quality evaluation value. This completes the movement of the gateway 14 in the load balancing process.

As described above, the present invention effectively balances the load conditions of controllers in the network, prevents controller overload, and improves the stability and reliability of the network system.

Many details are often found in the relevant art and many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A system configured for balancing load in a software-defined wireless sensor network, the system comprising:
at least one gateway configured to connect to multiple nodes, creating multiple transmission paths;
at least one first controller configured to manage the at least one gateway, detect a load of the multiple transmission paths, and issue an overload warning message when a ratio of overloaded of the multiple transmission paths exceeds a threshold value; and
a second controller configured to connect to the at least one first controller, add the at least one first controller issuing the overload warning message to an observation list when receiving the overload warning message, and stop migrating new gateways to the at least one first controller in the observation list for management.

2. The system of claim 1, wherein the second controller further receives load information sent by the at least one first controller, and the at least one first controller is added to a high-load list when the load information sent by the at least one first controller exceeds the load threshold; and at least one first controller is added to a low-load list when the load information sent by the at least one first controller is below the load threshold.

3. The system of claim 2, wherein the load information further comprising a processor usage rate of the at least one first controller and a total number of packets processed by the at least one first controller; wherein the load threshold further comprising a processor usage rate threshold and a total packet processing threshold; and the load information is defined as exceeding the load threshold when the second controller determines that the processor usage rate exceeds the processor usage rate threshold and the total number of packets processed exceeds the total packet processing threshold.

4. The system of claim 2, wherein the load information further comprising a processor usage rate of the at least one first controller and a total number of packets processed by the at least one first controller; wherein the load threshold further comprising a processor usage rate threshold and a total packet processing threshold; and the load information is defined as below the load threshold when the second controller determines that the processor usage rate is below the processor usage rate threshold and the total number of packets processed is below the total packet processing threshold.

5. The system of claim 2, wherein the load information further comprising a processor usage rate of the at least one first controller and a total number of packets processed by the at least one first controller; wherein the load threshold further comprising a processor usage rate threshold and a total packet processing threshold; and the load information is defined as exceeding the load threshold when the second controller determines that the processor usage rate exceeds the processor usage rate threshold or the total number of packets processed exceeds the total packet processing threshold.

6. The system of claim 2, wherein the second controller selects the gateway with the highest load managed by the at least one first controller in the high-load list; estimates the connection quality evaluation value between each first controller in the low-load list and the gateway with the highest load, and migrates the gateway with the highest load to the at least one first controller with the highest connection quality evaluation value for management.

7. The system of claim 6, wherein the second controller further utilizes an evaluation formula to estimate the connection quality evaluation value, the evaluation formula being as follows:
$$E = {W}_{l} \times ( {L}_{thres} - {L}_{curr} ) - {W}_{h} \times {H}_{count} ,$$
where the E is the connection quality evaluation value, the Wₗ and the Wₕ are weights, the Lₜₕᵣₑₛ is a load limit of the at least one first controller, the L_{curr} is a load value of one of the at least one first controller in the low-load list, and the H_{count} is the number of relay points through which the at least one of gateway with the highest load connected to one of the at least one first controller in the low-load list.

8. The system of claim 2, wherein the at least one first controller further comprising adjusts a reporting frequency of the load information sent to the second controller, and the reporting frequency increases as the load of the at least one first controller increases.

9. The system of claim 2, wherein the at least one first controller further adjusts a reporting frequency of the load information sent to the second controller, the reporting frequency being adjusted according to the following a reporting frequency equation:
$${F}_{{t}_{i}} = \frac{{R}_{{t}_{i}} - {R}_{{t}_{i - 1}}}{{t}_{i} - {t}_{i - 1}} ,$$
the Fₜ_{ᵢ} is the reporting frequency, the tᵢ is a time point, and the Rₜ_{ᵢ} is expressed by the following equation:
$${R}_{{t}_{i}} = \frac{\sum {T}_{packet \_ OUT} - {T}_{packet \_ IN}}{Packet\_Count} ,$$
the T_{packet_OUT} is amount of packets output by the at least one first controller, the T_{packet_IN} is amount of packets input to the at least one first controller, and the Packet_Count is total number of packets input and output by the at least one first controller.

10. The system of claim 1, wherein the at least one first controller estimates the load of the transmission paths based on traffic statistics of the at least one gateway and the nodes.

11. A method of balancing load in a software-defined wireless sensor network, the method comprising:
detecting, by at least one first controller, a load of multiple transmission paths between at least one gateway and multiple nodes;
issuing, by the at least one first controller, an overload warning message when a ratio of overloaded of the multiple transmission paths exceeds a threshold value; and
adding the at least one first controller that issued the overload warning message to an observation list when receiving the overload warning message, and stopping migrate of new gateways to the at least one first controller in the observation list for management.

12. The method of claim 11, further comprising:
receiving, by the second controller, the load information sent by the at least one first controller, and adding the at least one first controller to a high-load list when the load information sent by the at least one first controller exceeds a load threshold; and
adding the at least one first controller to a low-load list when the load information sent by the at least one first controller is below the load threshold.

13. The method of claim 12, wherein the load information further comprising a processor usage rate of the at least one first controller and a total number of packets processed by the at least one first controller; wherein the load threshold further comprising a processor usage rate threshold and a total packet processing threshold; and the load information is defined as exceeding the load threshold when the second controller determines that the processor usage rate exceeds the processor usage rate threshold and the total number of packets processed exceeds the total packet processing threshold.

14. The system of claim 12, wherein the load information further comprising a processor usage rate of the at least one first controller and a total number of packets processed by the at least one first controller; wherein the load threshold further comprising a processor usage rate threshold and a total packet processing threshold; and the load information is defined as below the load threshold when the second controller determines that the processor usage rate is below the processor usage rate threshold and the total number of packets processed is below the total packet processing threshold.

15. The system of claim 12, wherein the load information further comprising a processor usage rate of the at least one first controller and a total number of packets processed by the at least one first controller; wherein the load threshold further comprising a processor usage rate threshold and a total packet processing threshold; and the load information is defined as exceeding the load threshold when the second controller determines that the processor usage rate exceeds the processor usage rate threshold or the total number of packets processed exceeds the total packet processing threshold.

16. The method of claim 12, further comprising:
selecting, by the second controller, the gateway with the highest load managed by the at least one first controller in the high-load list;
estimating the connection quality evaluation value between each first controller in the low-load list and the gateway with the highest load; and
migrating the gateway with the highest load to the at least one first controller with the highest connection quality evaluation value for management.

17. The method of claim 16, wherein estimating the connection quality evaluation value further comprising utilizing an evaluation formula to estimate the connection quality evaluation value, the evaluation formula being as follows:
$$E = {W}_{l} \times ( {L}_{thres} - {L}_{curr} ) - {W}_{h} \times {H}_{count} ,$$
where the E is the connection quality evaluation value, the Wₗ and the Wₕ are weights, the Lₜₕᵣₑₛ is a load limit of the at least one first controller, the L_{curr} is a load value of one of the at least one first controller in the low-load list, and the H_{count} is the number of relay points through which the at least one of gateway with the highest load connected to one of the at least one first controller in the low-load list.

18. The method of claim 12, further comprising adjusting, by the at least one first controller, a reporting frequency of the load information sent to the second controller, and the reporting frequency increases as the load of the at least one first controller increases.

19. The method of claim 12, further comprising:
adjusting, by the at least one first controller, a reporting frequency of the load information sent to the second controller through a reporting frequency equation, the reporting frequency equation being as follows:
$${F}_{{t}_{i}} = \frac{{R}_{{t}_{i}} - {R}_{{t}_{i - 1}}}{{t}_{i} - {t}_{i - 1}} ,$$
the Fₜ_{ᵢ} is the reporting frequency, the tᵢ is a time point, and the Rₜ_{ᵢ} is expressed by the following equation:
$${R}_{{t}_{i}} = \frac{\sum {T}_{packet \_ OUT} - {T}_{packet \_ IN}}{Packet\_Count} ,$$
the T_{packet_OUT} is amount of packets output by the at least one first controller, the T_{packet_IN} is amount of packets input to the at least one first controller, and the Packet_Count is total number of packets input and output by the at least one first controller.

20. The method of claim 12, wherein estimating the load of the transmission paths further comprising estimating based on traffic statistics of the at least one gateway and the nodes.
